(19) United States
(12) Patent Application Publication
(10) Pub. No.: US 2006/0242624 A1
(43) Pub. Date: Oct. 26, 2006

(54) Apparatus and method for constructing a semantic layer based on XBRL data

(75) Inventor: Diane Carol Mueller-Klingspor, Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Business Objects, S.A. Levallois-Perret (FR)

(21) Appl. No.: 11/112,958

(22) Filed: Apr. 22, 2005

(51) Int. Cl. G06F 9/44

(52) U.S. Cl. 717/114

(57) ABSTRACT

A computer readable medium includes executable instructions to construct a semantic layer schema based on an XBRL data source and maintain the integrity of the XBRL metadata. The XBRL data can then be loaded into the semantic layer schema, and refreshed, such that the XBRL data is assessed and the semantic layer schema is updated as required.

### CROSS-REFERENCE TO RELATED APPLICATION

This application is related to the following concurrently filed, commonly owned patent application, which is incorporated by reference herein: Apparatus and Method for Transforming XBRL Data Into a Database Schema, Ser. No. ______, filed Apr. 22, 2005.

### BRIEF DESCRIPTION OF THE INVENTION

This invention relates generally to processing digital data. More particularly, this invention relates to a method for constructing a semantic layer based on eXtensible Business Reporting Language (XBRL) data to facilitate Business Intelligence data processing.

### BACKGROUND OF THE INVENTION

Business Intelligence generally refers to software tools used to improve business enterprise decision-making. More specifically, these tools can include: reporting and analysis tools to present information; content delivery infrastructure systems for delivery and management of reports and analytics; data warehousing systems for cleansing and consolidating information from disparate sources; and, data management systems, such as relational databases used to collect, store, and manage raw data.

The ability to work with various data sources is a key aspect of Business Intelligence tools. In order to separate the user from the complexity of the data source, a semantic layer provides an intermediate level that represents the underlying data to the user in easy to understand business terms. Regardless of the initial format and structure of the underlying data, a business wants to be able to work with the data and combine the different data sources together without requiring an understanding of the underlying database or data source structure. The semantic layer provides business users with easily understood business terms to access underlying data. This makes the semantic layer an important tool for working with data. The semantic layer is not in itself unknown, as it already exists in such products as Business Objects Universe Designer sold by Business Objects Americas, San Jose, Calif. This invention facilitates the construction of such a semantic layer based on eXtensible Business Reporting Language (XBRL) data.

XBRL data is a source of business financial information that businesses would like to be able to access and analyze with the same ease of use as other data sources. XBRL is an extensible Markup Language (XML) based specification developed specifically for preparing, publishing, and analyzing the financial information of an enterprise. The financial information specified by XBRL includes such data as annual and quarterly reports, SEC filings, general ledger information, net revenue and accountancy schedules. XBRL has metadata within a Discoverable Taxonomy Set (DTS) and a document instance. Within the DTS, overarching structures and metadata within linkbases (such as formulas, calculations, presentation, and relationships within the data) are defined. Within the document instance, there are specific structures, such as tuples, and context information (including durations and units of measure) for the data. It would be desirable to use this structural information and metadata in the DTS and document instance to provide logic to construct a semantic layer that represents the XBRL data source. The semantic layer should facilitate access by Business Intelligence tools. Ideally, this would be done without the loss of the integrity of the metadata in the original XBRL or the loss of the abstraction and simplicity available when working with a semantic layer.

### SUMMARY OF THE INVENTION

The invention includes a computer readable medium with executable instructions to receive extensible Business Reporting Language (XBRL) data and associated metadata. The XBRL data and associated metadata is mapped into a semantic layer schema. The XBRL data and associated metadata is then loaded into the semantic layer schema.

The invention includes a computer readable medium with executable instructions to accept an extensible Business Reporting Language (XBRL) web service feed as a data source and create a semantic layer that is optimized to maintain the integrity of the XBRL metadata and structures. Once the semantic layer has been constructed, it can be populated with data from an XBRL data source. Using scheduling tools, the data in the semantic layer can be updated on-demand or at regularly scheduled intervals. When the data in the database and semantic layer is updated (e.g., based on the XBRL data source feed), an assessment occurs to determine if the database schema or tables need to be extended to accommodate new structures in the incoming XBRL. Similarly, when the data is updated the semantic layer is assessed to determine if the semantic layer or its fields need to be updated. The structure of the incoming XBRL is compared to the existing semantic layer to determine whether the semantic layer needs to be modified or extended.

The invention makes use of existing Extraction, Transformation, Loading (ETL) tools in order to extract data, map data, extend schema, load data, and schedule data. This set of tools, referred to as the ETL platform throughout the disclosure includes optional web service adapter(s), data extraction tools, mapping tools, loading tools, and scheduling tools. The ETL process is not in itself unknown, as it already exists in such products as Business Objects Data Integrator, sold by Business Objects Americas, San Jose, Calif. The innovation includes specific strategies and logic for handling XBRL and maintaining the integrity of the metadata.

The invention also includes a computer readable medium storing executable instructions to construct the semantic layer for the XBRL document instance and DTS. The executable instructions include executable instructions to interpret XBRL that is supplied as a web service data source and assess whether there is an existing semantic layer with which the data can be associated, and to construct the semantic layer if it does not exist, or to modify the semantic layer if the metadata in the XBRL changes and requires updates to the semantic layer. The semantic layer is constructed in such a way that the integrity of the metadata within the document instance and DTS is maintained and optimized. If the schema and table structure do not require modifications, the semantic layer is updated with any field content changes. The user is allowed to schedule updates to the database and semantic layer or run the process on-demand.

This semantic layer can be saved to a computer readable medium and be accessed by other users and other programs. The invention provides a set of logical relationships for defining the relationships and metadata within the XBRL and matching that to relationships within a semantic layer structure that is designed to maintain the relationships. Advantageously, the invention enables users without a specific understanding of XBRL data structures or relational database design to access data based on an XBRL data source using a semantic layer that abstracts the data logic so that the user can create reports and use other Business Intelligence tools without having specific technical skills or knowledge.

### BRIEF DESCRIPTION OF THE FIGURES

The invention is more fully appreciated in connection with the following detailed description taken in conjunction with the accompanying drawings, in which:

FIG. 1 illustrates the overall business context and the type of system within which the invention can be implemented.

FIG. 2 illustrates processing of XBRL source data in accordance with an embodiment of the invention.

FIG. 3 illustrates processing of XBRL source data in accordance with an embodiment of the invention.

FIG. 4 illustrates the relationship between an XBRL document instance and a discoverable taxonomy set (DTS), which is used to identify the XBRL logic and metadata that is maintained in constructed semantic layer schema and fields.

FIG. 5 illustrates a Graphical User Interface (GUI) tool used for viewing and designing semantic layers in accordance with an embodiment of the invention.

FIG. 6 illustrates the relationship between XBRL metadata and a semantic layer constructed in accordance with an embodiment of the invention.

FIG. 7 illustrates a general process used to construct a semantic layer based on an XBRL data source in accordance with an embodiment of the invention.

Like reference numerals refer to corresponding parts throughout the several views of the drawings.

### DETAILED DESCRIPTION OF THE INVENTION

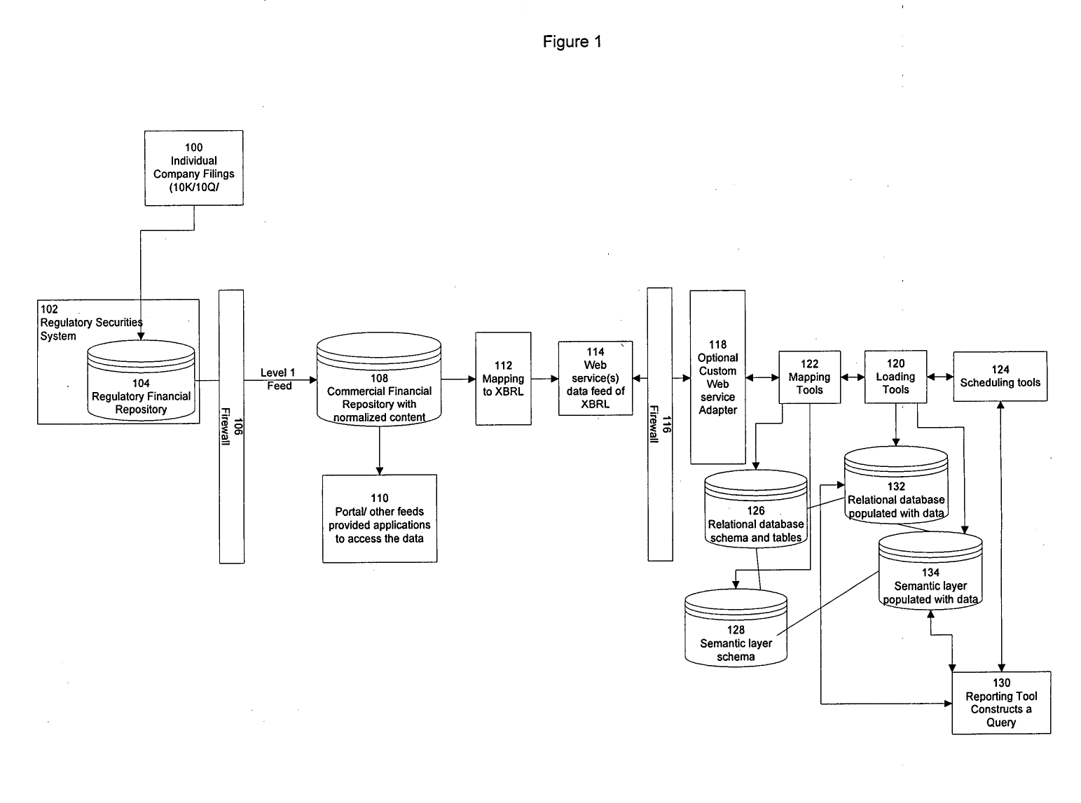

FIG. 1 illustrates an example of the overall business context and type of system within which the invention can be implemented. An individual company files a report 100 with a regulatory agency (e.g., the U.S. Securities and Exchange Commission) 102. This filing may be made electronically or through any other means. The regulatory body then stores this report within a repository 104. The regulatory body may need to scan this document and may normalize the report. The regulatory body provides a data feed service for its filings. Typically, subscribers to the data feed are external financial services that are outside the regulatory body's firewall 106. The commercial repository system 108 may normalize the content if it has not previously been normalized. An example of this sort of commercial financial repository is Edgar Online, which receives data from the U.S. Securities and Exchange Commission, normalizes the data and stores the data. Thereafter, the data is accessible, for example, via a web service based XBRL data source feed. This commercial financial repository may be accessible through any number of portals and applications 110.

The data within the commercial financial repository is mapped to XBRL 112. When a regulatory body provides the XBRL data source directly (e.g., via an XBRL web service provided by the regulatory body), components 108, 110, and 112 are not required. In this example, the web service(s) 114 are shown as being provided by a commercial financial repository, merely to illustrate one potential implementation. The web services 114 may contain more than one web service in order to accommodate information other than the XBRL data source, such as user identification and authentication. Typically, this web service is separated by a firewall 116.

The invention may be supported by any required web service adapters 118 that are specific to the web service data feed format that is being processed. The web service adapter can handle such issues as variance in standard/security levels, as well as any specific aspects specific to the provided web services, such as authentication. The invention works within an ETL framework, with Mapping Tools 122 that discover the schema based on the data source and extracts the metadata and structural information from the XBRL data source. Based on optimizations specific to the data structure discovered, a database schema and related tables are constructed 126. A semantic layer schema 128 is also constructed. At this point, the database and semantic layer are not populated with specific data. Loading tools 120 load the specific data within the database tables 132, and load the semantic structure 134. In other words, the schema and tables 126 are now populated with the data from the XBRL data source to construct a database that contains the information from the XBRL data source 132 and that can be queried directly. Similarly, the semantic layer schema 128 is populated with the specific labels and fields 134 to construct a semantic layer that contains the specific metadata 134.

Scheduling Tools 124 are used to schedule when the data within the database 132 will be updated. Reporting tools 130 enable the user to construct a query, this query can then be applied against the database 132 or semantic layer 134 or can be run against the web service data feed using the scheduling tools 124. In addition to queries defined by users, queries can be defined and run or scheduled programmatically.

FIG. 1 illustrates three phases, the first being a collection phase, using components 100-106. The collection phase involves a regulatory body collecting data and providing a data feed service. The second phase is optional, involving a commercial financial service that provides a web service based XBRL data feed using components 108-116. The third phase is focused on Business Intelligence tools and the ability to work with and analyze data. This phase is implemented with components 118-134.

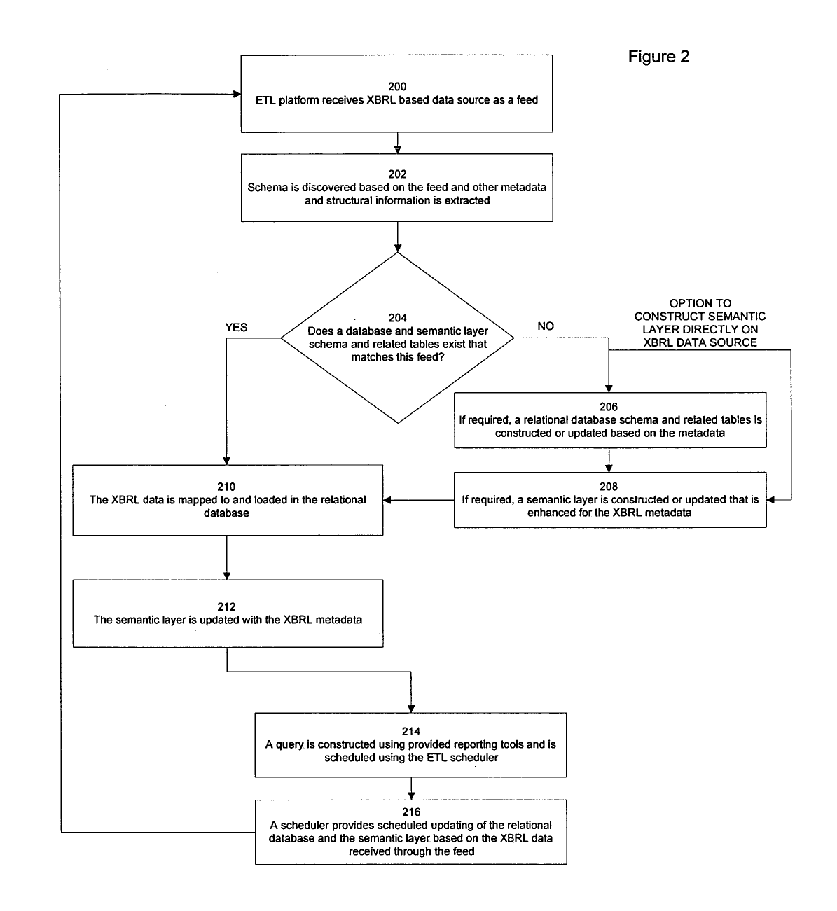

FIG. 2 illustrates one implementation of an Extraction, Transformation, Loading (ETL) process handling an XBRL data source in accordance with an embodiment of the invention. After the ETL platform receives the XBRL based data source 200, it discovers the schema based on the data source and other metadata and structural data 202. For example, executable instructions associated with mapping tools 122 may be used to implement this operation. The XBRL data source is then validated against any existing database and semantic layer structures and tables to confirm that there is a pre-existing database and that no updates or modifications to the schema or additional tables are required 204. If either the construction of a new database or modifications to an existing database are required, the database schema/tables are constructed or updated 206 and the semantic layer is constructed or updated 208. Executable instructions associated with the mapping tools 122 may be used to implement these operations.

Once the database has been validated and it is confirmed that the database contains the appropriate structure and tables, the XBRL data is loaded into the database 210. Executable instructions associated with loading tools 120 may be used to implement this operation.

Optionally, the semantic layer is updated with the XBRL metadata 212. A query is then constructed using reporting tools 214. For example, executable instructions associated with the reporting tool 130 of FIG. 1 may be used to implement this operation. Executable instructions associated with the scheduling tools 124 may be used to launch a query in accordance with a specified schedule. The final operation associated with the process of FIG. 2 is to use a scheduler (e.g., scheduling tools 124) to update the relational database and optionally the semantic layer 216. A scheduled or on-demand query triggers the process 200 of receiving XBRL data and validating the data against the existing database/semantic layer structure.

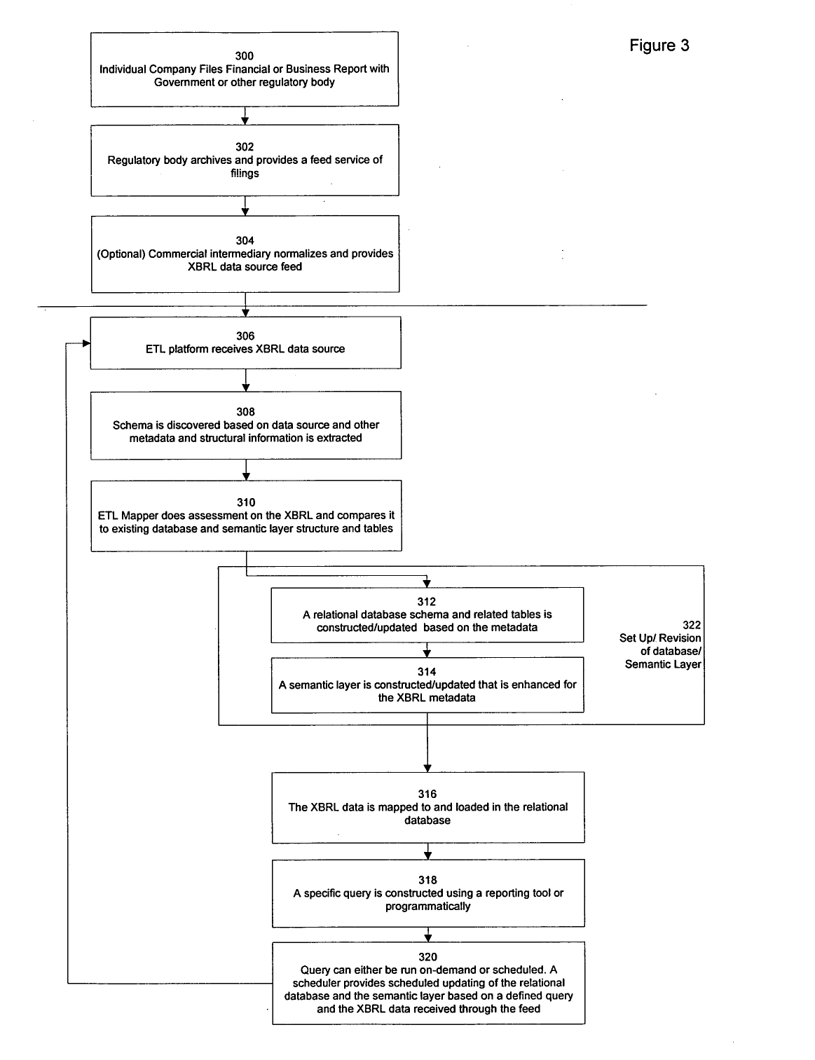

FIG. 3 illustrates processing associated with an embodiment of the invention. Currently, in many countries the government, or another regulatory body, collects financial reports from companies 300, archives those reports and provides data feed services 302, commercial intermediaries may normalize this data and provide it as an XBRL data source. In the case when the regulatory body itself provides an XBRL data feed, the invention can work directly with that data source rather than requiring a commercial intermediary 304 to provide the data source.

The ETL platform receives the XBRL based data source 306. As shown in FIG. 1, custom web service adapters or other interfaces may be required to access the XBRL data source. The schema (and other relevant metadata and structural information) is discovered based on the data source 308. The ETL mapper validates the data source against any existing database and semantic layer 310. If no database exists or modifications to the existing database are required, the database is constructed or updated 312. If no semantic layer exists, or modifications to the existing semantic layer are required, the semantic layer is constructed or updated 314. Steps 312 and 314 are part of a Set Up/Revision process 322 that occurs either the first time that a query is run or when the metadata in the XBRL data source has changed in such a way that the database should reflect the change in order to provide an optimized schema and the appropriate tables. Generally, when a query is run, an assessment 310 indicates whether an alteration is required and the data is mapped and loaded within the existing relational database 316. Queries are constructed either programmatically or using a reporting tool with a graphical user interface (GUI). Queries can be executed programmatically or using the reporting tools 318. When a query is executed on demand or scheduled 320, the process begins with the ETL platform receiving the XBRL based data source 306. The query can also be run against the static data within the database, if there is no need to refresh the data from the XBRL data source.

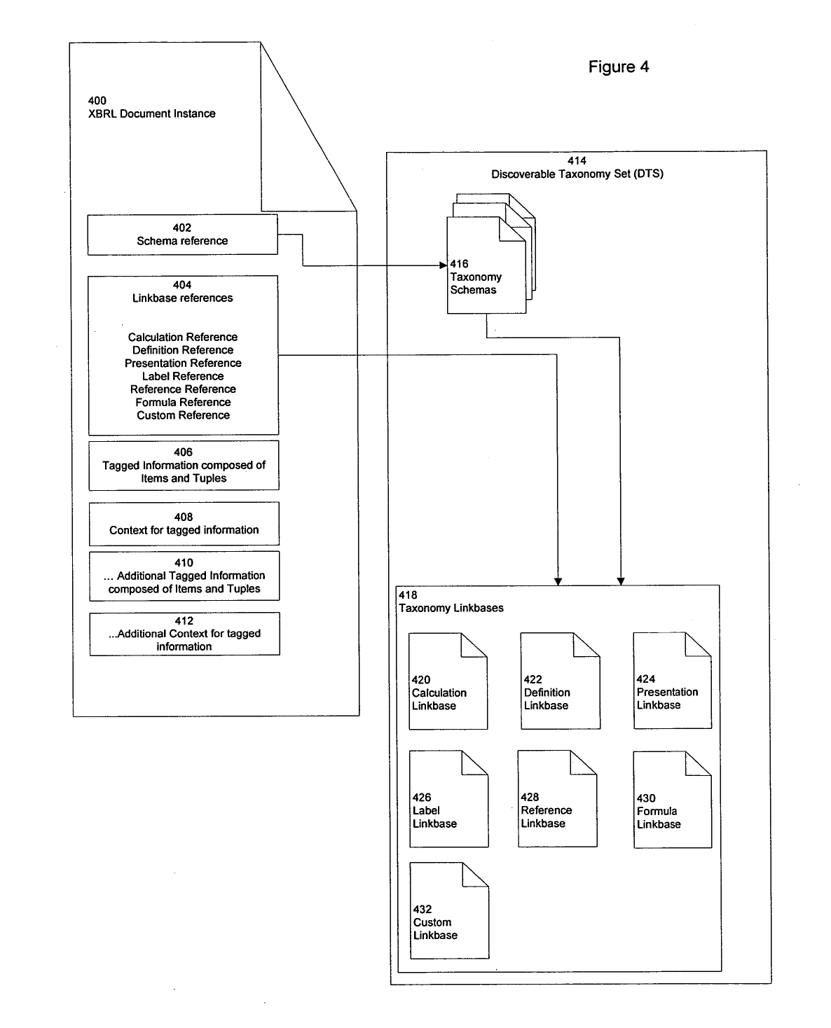

FIG. 4 illustrates the relationship between an XBRL document instance 400 and a discoverable taxonomy set (DTS) 414. The XBRL document instance 400 is the “XML” (Extensible Markup Language) file that contains the data and also identifies the schema and taxonomy linkbases that the document instance depends on for its complete meaning. The schema 402 and link base references 404 generally point to resources available on the internet, but they can also refer to other files provided as accompanying physical files or by other means. Below is an example of how the document instance references a schema 416 and linkbase 418 located on the internet:

<schema targetNamespace=”http://www.xbrl.org/2003/instance”
xmlns=″http://www.w3.org/2001/XMLSchema″
xmlns:xbrli=″http://www.xbrl.org/2003/instance″
xmlns:link=″http://www.xbrl.org/2003/linkbase″
elementFormDefault=″qualified″>

In addition to referencing external documents, the XBRL document instance also contains meaning within its own structure. As sections 406 and 410 illustrate, the data contains discrete items, as well as tuples (collections of data items and potentially additional tuples related to the same overall fact). In addition to the data, there is also explanatory context information for the data 408 and 412. The context information provides information that makes the data itself more meaningful. For example, in the following XML, two values “2584000” and “2077000” constitute a tuple that relates to “ifrs-gp:AssetsTotal.” Both values have context references that provide metadata that explains each value:

<ifrs-gp:AssetsTotal contextRef=“Current_AsOf”
unitRef=“U-Euros”>

2584000</ifrs-gp:AssetsTotal>

<ifrs-gp:AssetsTotal contextRef=“Prior_AsOf”
unitRef=“U-Euros”> 2077000</ifrs-

gp:AssetsTotal>

For each value, context information for a period and unit is provided. These contexts are defined elsewhere within the document instance. For example, in this case the period “Prior_AsOf” is defined:

<context id=“Prior_AsOf”>
<entity>
<identifier scheme=“http://www.sampleCompany.com”>Sample
Company</identifier>
</entity>
<period>
<instant>2004-12-31</instant>
</period>
</context>

Similarly the context information for the unit is specified:

<unit id=“U-Euros”>
<measure>iso4217:EUR</measure>
</unit>

The invention maintains the relationship of the two items for “ifrs-gp:AssetsTotal” and the contextual information for the items when constructing database schemas and tables.

In addition to the metadata located within the document instance 400, the DTS 414 provides another layer of metadata. A number of taxonomy schemas and linkbases can be associated with the document instance and these schemas and linkbases provide additional XBRL metadata. The taxonomy schemas contain additional metadata concerning the acceptable relationships between the data items and how they are structured. The linkbases are typically classified within three categories of metadata: label links, reference links, and relation links. Label links are defined in the label linkbase 426 and typically define a standard label for a business concept (using the label element), a locator for the business concept (using the loc element), and a link (or arc), connecting the business concept to the label (using the labelArc element).

Reference links are defined in the reference linkbase 428. Typically, reference links associate references to authoritative background or definition information in the business domain. The reference mechanism used is similar to the label links in that a reference link is defined with a locator for the business concept, one or more references to documentation, and a referenceArc defining the association between the locator and the reference(s). Relation links are defined in linkbases such as: calculation linkbase 420, definition linkbase 422, presentation linkbase 424, and formula linkbase 430.

In contrast to label and reference links that relate business concepts to metadata, relation links relate business concepts to other business concepts. For example, calculation links define how a given concept figures in the calculation of another business concept. For example, the concept “profitAfterTax” is calculated from the concepts “profitBeforeTax” and “taxPaid” by subtracting one from the other. For example, profitAfterTax can be represented by the following formula:
profitAfterTax=weight(1)*profitBeforeTax+weight(−1)*taxPaid

The relationship between these three business concepts is captured in the calculationLink in the following:

<calculationArc

xlink:type= “arc”
xlink: arcrole= http://www.xbrl.org/2003role#summation-item\

xlink:from= “profitAfterTax”

xlink:to= “profitBeforeTax”
weight= “1.0”
order = “1” />

<calculationArc

xlink:type= “arc”
xlink: arcrole= http://www.xbrl.org/2003role#summation-item\

xlink:from= “profitAfterTax”

xlink:to= “taxPaid”
weight= “1.0”
order = “2” />

Definition links describe several types of relationships among business concepts, such as generalization-specialization relationships (e.g., “postalCode” is a generalization of “zipCode”) and other relationships between business concepts.

Presentation links, as the name implies, define the relationships between concepts from a presentation perspective (e.g., in the presentation of the report, a parent/child relationship should be shown between “sales” and “telephoneSales”). The presentation linkbase is particularly important when extrapolating the semantic layer schema because it provides the information that is used to construct the class and sub-class hierarchy. In addition to the standard linkbases, additional custom linkbases 432 can be defined to extend the logic of the existing linkbases.

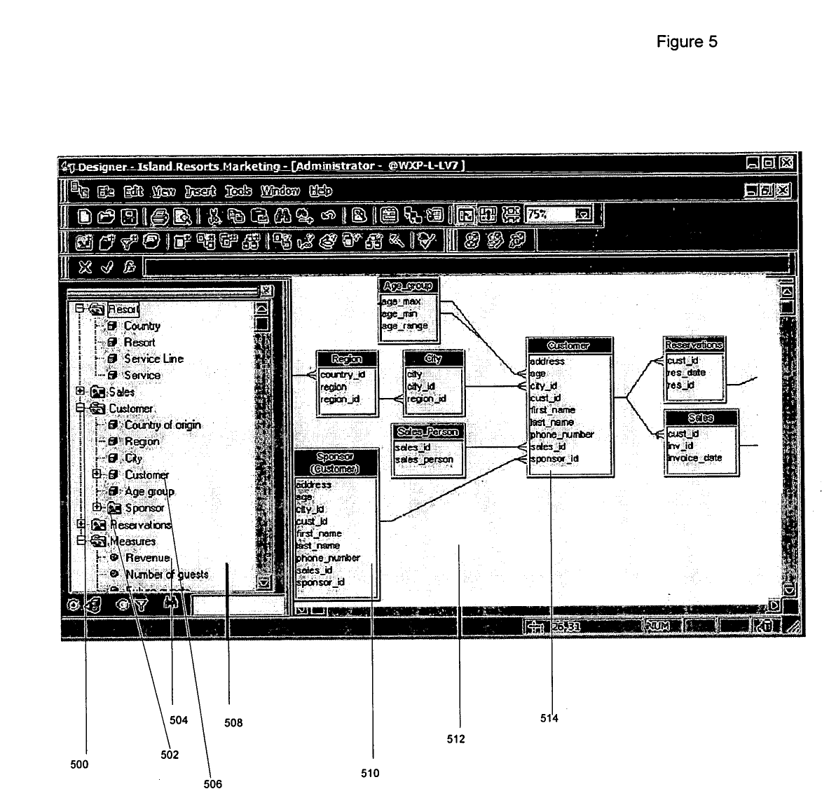

FIG. 5 illustrates a Graphical User Interface (GUI) tool used for viewing and designing semantic layers in accordance with an embodiment of the invention. Semantic layers are constructed from classes and subclasses. Classes and subclasses can contain objects. There are three typical types of objects contained within a class (or subclass): dimensions, details, and measures. The illustrative GUI displays the information in two formats: the class pane 508 and the structure pane 512. In the class pane, classes such as Customers 500 and subclasses such as Sponsor 502 are displayed. These classes and subclasses can contain dimensions such as “Customer” 506 and measures such as “Revenue” 504. Classes can also contain details (not shown) which provide additional information about a dimension. For example, the dimension “Customer” 506 can be expanded and can contain details such as “Address” or “Phone number”. The structure pane shows the schema that is defined for the semantic layer including the joins between tables. The class Customer 500 is shown as a table 514 and the subclass Sponsor 502 is shown as a table 510. The invention generates an initial proposed semantic layer based on the structure and metadata within the DTS and document instance and a user is allowed to accept or alter the proposed semantic layer design.

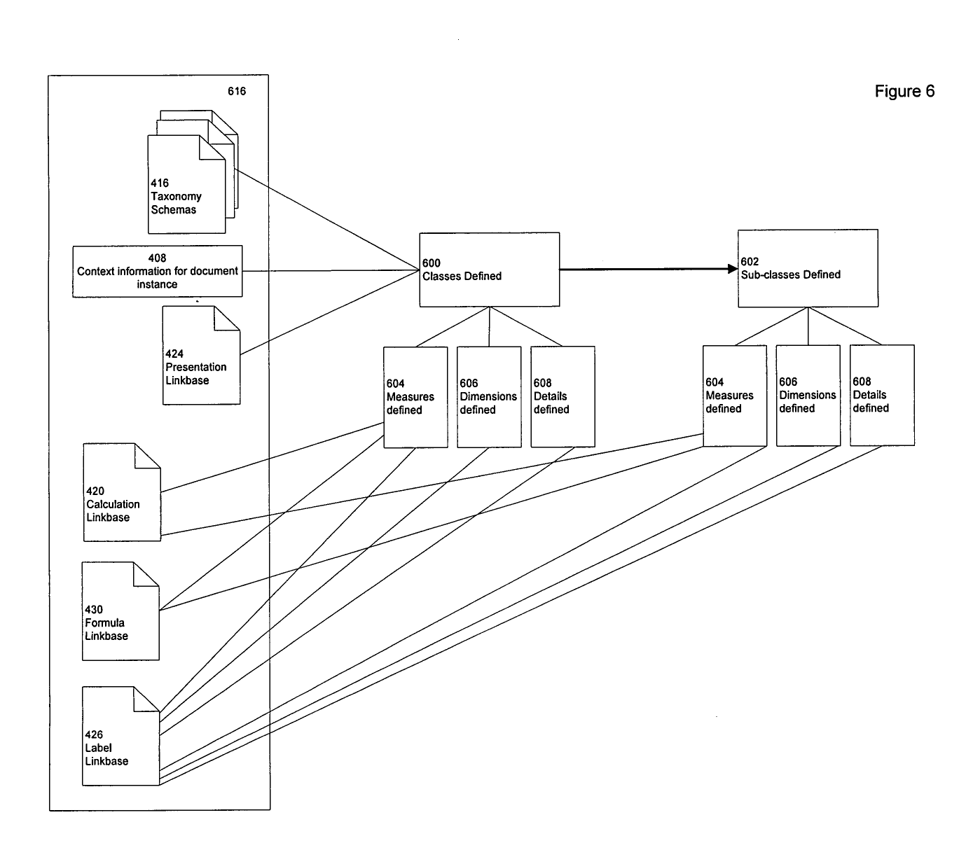

FIG. 6 illustrates the relationship between XBRL metadata and an exemplary semantic layer. The metadata aspects from the DTS and document instance that are typically used in constructing a semantic layer 616 connect to the definition of classes 600, subclasses 602 and measures 604, dimensions 606, and details 608 within the semantic layer.

Taxonomy schemas 146, context information for the document instance 408, and the presentation linkbase 424 are used to define the class hierarchies and the parent child relationships between the classes. The taxonomy schemas 416, context information for the document instance 408, and the presentation linkbase 424 are used not only to define the classes and subclasses, but also the dimensions, details, and measures within the classes and subclasses.

For each individual class and subclass, dimensions 606, details 608, and measures 604 can be defined. Typically, a semantic layer might contain a significant number of classes and each class could contain a number of dimensions, details, and measures. Dimensions 606 can contain details 608 that provide additional information that pertains to the dimension item. For example, a Customer class might contain a dimension for customer address and that dimension might contain detail objects for street, city, and state. A class can contain zero or more of each of the three elements (measure, dimension, detail).

Measures are defined using the calculation linkbase 420 and the formula linkbase 430, but metadata from the taxonomy schemas 416, context information for the document instance 408, and the presentation linkbase 424 ensure that measures are associated with the appropriate class.

All three of the data objects (dimensions, details, and measures) are also informed by the label linkbase 426 that provides primary and alternative labels (or descriptions) for the objects.

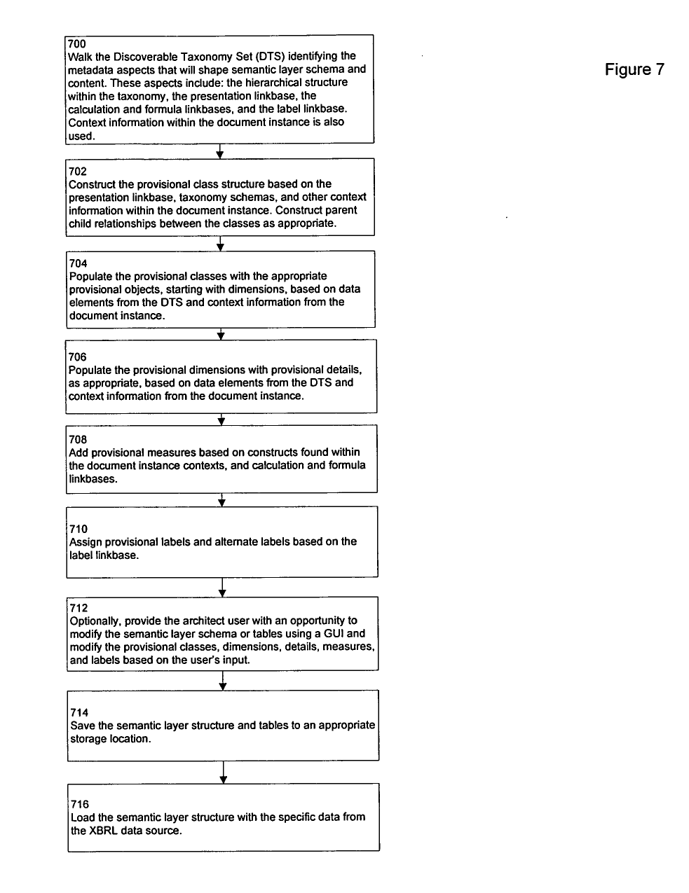

FIG. 7 illustrates a process to construct a semantic layer based on an XBRL data source. First, the DTS is scanned in order to identify the metadata aspects that will shape the semantic layer. The types of aspects that are considered include: the hierarchical structure within the schema(s), the presentation linkbase, the calculation linkbase, the formula linkbase and the label linkbase 700. In addition to scanning the DTS, context information from the document instance is also used to determine connections within the semantic layer.

A provisional class structure is constructed based on the presentation linkbase, taxonomy schemas, and other context information within the document instance 702. Parent child relationships between the classes are used when appropriate.

The provisional classes are populated with the appropriate provisional objects, starting with dimensions, based on data elements from the DTS 704 and context information from the document instance. The provisional dimensions are populated with provisional details, as appropriate, based on data elements from the DTS and context information from the document instance 706. Provisional measures are added based on constructs found within the document instance contexts, and calculation and formula linkbases 708. Provisional labels and alternate labels are assigned to the dimensions, details, and measures based on information in the label linkbase 710

Optionally, a user views the provisional semantic layer schema or tables using a GUI. The user may modify the provisional classes, dimensions, details, measures, and labels that characterize the data source 712. The semantic layer structure and tables are saved to an appropriate storage location 714. The semantic layer structure is then loaded with the specific data from the XBRL data source 716.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium comprising executable instructions to:
receive extensible Business Reporting Language (XBRL) data and associated metadata;
map said XBRL data and associated metadata into a semantic layer schema; and
load said XBRL data and associated metadata into said semantic layer schema.

2. The computer readable medium of claim 1 wherein said executable instructions to map include executable instructions to map said XBRL data and associated metadata into a semantic layer schema in which classes and subclasses contain objects that are defined against a relational database containing said XBRL data.

3. The computer readable medium of claim 1 wherein said executable instructions to map include executable instructions to map said XBRL data and associated metadata into a semantic layer schema in which classes and subclasses contain objects that are defined against said XBRL data.

4. The computer readable medium of claim 1 wherein said executable instructions to map include executable instructions to create a semantic layer schema at the same time that said XBRL data and associated metadata are mapped to a relational database.

5. The computer readable medium of claim 1 wherein said executable instructions to map include executable instructions to validate whether a semantic layer exists with required schema, and if not, construct required schema corresponding to said XBRL data and associated metadata.

6. The computer readable medium of claim 5 further comprising executable instructions to supply recommended schema to a user.

7. The computer readable medium of claim 6 further comprising executable instructions to allow alterations to recommended schema.

8. The computer readable medium of claim 1 wherein said executable instructions to receive include executable instructions to receive from a commercial XBRL data source.

9. A computer readable medium comprising executable instructions to:
receive data with a discoverable taxonomy and linkbase;
map said data into a semantic layer schema; and
load said data into said semantic layer schema.

10. The computer readable medium of claim 9 wherein said executable instructions to map include executable instructions to map said discoverable taxonomy into a semantic layer schema in which classes and subclasses contain objects that are defined against a relational database containing said data.

11. The computer readable medium of claim 9 wherein said executable instructions to map include executable instructions to map said discoverable taxonomy into a semantic layer schema in which classes and subclasses contain objects that are defined against an eXtensible Markup Language (XML) data source containing said data.

12. The computer readable medium of claim 9 wherein said executable instructions to map include executable instructions to create a semantic layer schema at the same time that said discoverable taxonomy and data are mapped to a relational database.

13. The computer readable medium of claim 9 wherein said executable instructions to map include executable instructions to validate whether a semantic layer exists with required schema, and if not, construct required schema corresponding to said discoverable taxonomy and data.

14. The computer readable medium of claim 13 further comprising executable instructions to supply recommended schema to a user.

15. The computer readable medium of claim 14 further comprising executable instructions to allow alterations to recommended schema.

16. The computer readable medium of claim 9 wherein said executable instructions to receive include executable instructions to receive from a commercial XBRL data source.

17. The computer readable medium of claim 9 further comprising executable instructions to query a relational database using said semantic layer.

18. The computer readable medium of claim 17 wherein said executable instructions to query include executable instructions to query a database using said semantic layer in a reporting tool.

19. The computer readable medium of claim 9 further comprising executable instructions to query an eXtensible Markup Language (XML) data source using said semantic layer.

20. The computer readable medium of claim 19 wherein said executable instructions to query include executable instructions to query an XML data source using said semantic layer in a reporting tool.
